(19) United States
(12) Patent Application Publication
(10) Pub. No.: US 2012/0110679 A1
(43) Pub. Date: May 3, 2012

(54) SERVICE PROVIDING SYSTEM, SERVICE PROVIDING METHOD, PORTABLE COMMUNICATION TERMINAL AND SERVER

(75) Inventors: Tomoyuki Asano, Kanagawa (JP); Masakazu Ukita, Kanagawa (JP); Masanobu Katagi, Kanagawa (JP); Yohei Kawamoto, Tokyo (JP); Yu Tanaka, Tokyo (JP); Seiichi Matsuda, Tokyo (JP); Shiho Moriai, Kanagawa (JP)

(73) Assignee: SONY CORPORATION, Tokyo (JP)

(21) Appl. No.: 13/274,708

(22) Filed: Oct. 17, 2011

(30) Foreign Application Priority Data
Oct. 29, 2010 (JP) P2010-244057

(51) Int. Cl. G06F 21/24

(52) U.S. Cl. 726/29

(57) ABSTRACT

A service providing system includes a portable communication terminal operated by a user; a service providing apparatus providing a service to the user, and a server managing the service providing apparatus, wherein the service providing apparatus calculates a response using a challenge, and the portable communication terminal transmits a challenge generated by the server to the service providing apparatus subjected to a legitimacy check of the service providing apparatus and presents a result of the legitimacy check based on a response calculated by the service providing apparatus subjected to the legitimacy check using the transmitted challenge.

### BACKGROUND

The present disclosure relates to a service providing system, a service providing method, a portable communication terminal and a server. More specifically, it is possible to easily determine whether or not a service providing apparatus that provides a service to users is legitimate.

In recent, many services are provided using Internet. For example, web mail or online banking is often used daily. These services are very useful, but the fraudulent activity known as phishing has rapidly increased as a social problem.

Most of phishing is performed by intercepting web mail or online banking site, inducing users to a false site, inputting the user's own account number and password to the false site, and stealing them.

To prevent such criminal acts, for example, Japanese Unexamined Patent Application Publication No. 2007-128310 discloses a way of transmitting a session code from a communication terminal (for example, a portable phone) and a communication terminal (for example, a personal computer) requesting the service to a service providing server. The service providing server provides the service from personal computers to a user based on personal information of the user transmitted from the portable phone, when the session codes match each other.

### SUMMARY

Incidentally, deceptions such as phishing are not limited to the Internet, and there is concern over physical phishing occurring as well. For example, ATM (Automated teller machine) criminal of bank prepares a simulated facilities and buildings to induce the user there and steals cash card information and an authentication number presented by an unauthenticated user to use in crime.

As more small-scale criminal activities, a device or software, such as a key logger, which records user input, may be secretly attached to a computer provided in an Internet café a used by a number of users. A user unaware of such illegality has their account number and password when accessing web mail or online banking from the computer equipment.

Thus, it is desirable to provide a service providing system, a service providing method, a portable communication terminal and a server in order to easily determine the legitimacy of a service providing apparatus providing the service to a user in the disclosure.

According to an embodiment of the present disclosure, there is provided a service providing system including a portable communication terminal operated by a user; a service providing apparatus providing the service to the user, and a server managing the service providing apparatus, wherein the service providing apparatus calculates a response using a challenge, and the portable communication terminal transmits a challenge generated by the server to the service providing apparatus subjected to a legitimacy check among the service providing apparatus and presents a result of the legitimacy check based on a response calculated by the service providing apparatus subjected to the legitimacy check using the transmitted challenge.

The service providing apparatus calculates the response using the challenge in the disclosure. The portable communication terminal transmits the challenge to the service providing apparatus subjected to the legitimacy check. For example, the portable communication terminal transmits the challenge supplied from a server to the service providing apparatus subjected to the legitimacy check in response to the transmission of position information generated by a position information generation unit to the server. The service providing apparatus subjected to the legitimacy check calculates the response using key information and the challenge supplied from the portable communication terminal and transmits the calculated response together with a unique identification information of the service providing apparatus subjected to the legitimacy check.

Further, the portable communication terminal presents a result of the legitimacy check based on the response calculated by the service providing apparatus subjected to the legitimacy check. For example, the portable communication terminal transmits the response and the unique identification information supplied from the service providing apparatus subjected to the legitimacy check to the server. The server determines the key information from the unique identification information, compares the calculated response with the response calculated by the service providing apparatus subjected to the legitimacy check using the determined key information and the transmitted challenge, checks the legitimacy of the service providing apparatus subjected to the legitimacy check, and presents the check result to the portable communication terminal. Further, the server calculates the response calculated using the challenge in a legitimate service providing apparatus as an expected value to supply to the portable communication terminal. The portable communication terminal compares the expected value with the response calculated by the service providing apparatus subjected to the legitimacy check to check the legitimacy of the service providing apparatus subjected to the legitimacy check.

In addition, the server transmits authentication information that enables the user to determine the legitimacy of the portable communication terminal and the service providing apparatus at the position indicated by the position information, when the portable communication terminal does not display that the portable communication terminal is able to communicate with the service providing apparatus subjected to the legitimacy check, and the service providing apparatus subjected to the legitimacy check and the portable communication terminal present the authentication information.

According to another embodiment of the present disclosure, there is provided a service providing method for a service providing system including a portable communication terminal operated by a user; a service providing apparatus providing a service to the user, and a server managing the service providing apparatus, the service providing method including calculating a response using a challenge in the service providing apparatus; transmitting, by the portable communication terminal, a challenge generated by the server to the service providing apparatus subjected to a legitimacy check among the service providing apparatuses, and presenting, by the portable communication terminal, a result of the legitimacy check based on the response calculated by the service providing apparatus subjected to the legitimacy check using the transmitted challenge.

According to another embodiment of the present disclosure, there is provided a portable communication terminal including a position information generation unit generating a position information displaying a current position; a communication unit communicating a service providing apparatus providing a service to a user with a server managing the service providing apparatus, and a control unit transmitting a challenge generated by the server to the service providing apparatus subjected to the legitimacy check among the service providing apparatus and presenting the result of the legitimacy check based on a response calculated by the service providing apparatus subjected to the legitimacy check using the transmitted challenge.

According to another embodiment of the present disclosure, there is provided a server including a communication unit communicating a service providing apparatus providing a service to a user with a portable communication terminal operated by a user, and a control unit transmitting a challenge to a portable communication terminal, checking legitimacythe legitimacy of a service providing apparatus disposed at a position displayed by a position information based on a response supplied from the portable communication terminal, and transmitting a result of a legitimacy check to the portable communication terminal, when disposing the service providing apparatus at the position indicated by the position information supplied from the portable communication terminal.

According to another embodiment of the present disclosure, there is provided a service providing system including a portable communication terminal operated by a user; a service providing apparatus providing a service to the user, and a server managing the service providing apparatus, wherein the server transmits a first program calculating a response using a challenge and a second program checking legitimacy the legitimacy of the service providing apparatus subjected to the legitimacy check using the response obtained by allowing the service providing apparatus subjected to the legitimacy check among the service providing apparatus to execute and calculate the first program to the portable communication terminal, the portable communication terminal executes the second program, and checks the legitimacy of the service providing apparatus subjected to the legitimacy check using the response supplied from the service providing apparatus subjected to the legitimacy check in response to the transmission of the challenge and the first program to the service providing apparatus subjected to the legitimacy check and, the service providing apparatus subjected to the legitimacy check executes the first program supplied from the portable communication terminal to calculate the response using the challenge and transmits the calculated response to the portable communication terminal.

According to the present disclosure, the first program calculating the response using the challenge, and the second program checking legitimacy the legitimacy of the service providing apparatus subjected to the legitimacy check using the response obtained by allowing the service providing apparatus subjected to the legitimacy check to execute and calculate the first program are supplied in advance from the server to the portable communication terminal and are held. The challenge and the first program are transmitted to the service providing apparatus subjected to the legitimacy check from the portable communication terminal when checking the legitimacy of the service providing apparatus subjected to the legitimacy check. The service providing apparatus subjected to the legitimacy check transmits the response obtained by allowing the service providing apparatus subjected to the legitimacy check among the service providing apparatus to execute and calculate the first program to the portable communication terminal. Further, the server transmits a list displaying a position of the service providing apparatus together with the first program and the second program to the portable communication terminal. The portable communication terminal determines the service providing apparatus to an illegitimate when the service providing apparatus is not in the list.

According to another embodiment of the present disclosure, there is provided a service providing method for a service providing system including a portable communication terminal operated by a user; a service providing apparatus providing a service to the user, and a server managing the service providing apparatus, the service providing method including transmitting, by the server, a first program calculating a response using a challenge and a second program checking legitimacy the legitimacy of the service providing apparatus subjected to the legitimacy check using the response obtained by allowing the service providing apparatus subjected to the legitimacy check among the service providing apparatus to execute and calculate the first program to the portable communication terminal; executing, by the portable communication terminal, the second program checking the legitimacy of the service providing apparatus subjected to the legitimacy check using the response supplied from the service providing apparatus subjected to the legitimacy check in response to the transmission of the challenge and the first program to the service providing apparatus subjected to the legitimacy check, and executing, by the service providing apparatus subjected to the legitimacy check, the first program supplied from the portable communication terminal to calculate the response using the challenge and transmitting the calculated response to the portable communication terminal.

According to another embodiment of the present disclosure, there is provided a portable communication terminal including a communicating unit acquiring a first program calculating a response using a challenge when the service providing apparatus providing the service for the user is communicated with the server managing the service providing apparatus and a second program checking legitimacy the legitimacy of the service providing apparatus subjected to the legitimacy check using the response obtained by allowing the service providing apparatus subjected to the legitimacy check among the service providing apparatus to execute and calculate the first program, and a control unit executing the second program, checking the legitimacy of the service providing apparatus subjected to the legitimacy check using the response supplied from the service providing apparatus subjected to the legitimacy check in response to the transmission of the challenge and the first program to the service providing apparatus subjected to the legitimacy check, and presenting a result of the legitimacy check.

According to another embodiment of the present disclosure, there is provided a server managing a service providing apparatus providing a service to a user, including a communication unit communicating with a portable communication terminal operated by a user, and a control unit providing a first program calculating a response using a challenge according to a request from the portable communication terminal and a second program checking legitimacy the legitimacy of the service providing apparatus subjected to the legitimacy check using the response causing the first program to execute and calculate by the service providing apparatus subjected to the legitimacy check among the service providing apparatus.

According to the present disclosure, the service providing apparatus subjected to the legitimacy check calculates a response using a challenge. Further, the portable communication terminal transmits the challenge to the service providing apparatus subjected to the legitimacy check and presents the result of the legitimacy check based on a response calculated by the service providing apparatus subjected to the legitimacy check using the transmitted challenge. Therefore, the user can easily determine whether or not the service providing apparatus is legitimate.

### BRIEF DESCRIPTION OF THE DRAWINGS

FIG. 1 shows a configuration of a service providing system according to an embodiment of the present disclosure.

FIG. 2 shows a configuration of a service providing apparatus.

FIG. 3 shows a configuration of a server.

FIG. 4 shows a configuration of a portable communication terminal.

FIG. 5 shows a sequence diagram illustrating operation according to a first embodiment of the present disclosure.

FIG. 6 shows a sequence diagram illustrating operation according to a second embodiment of the present disclosure.

FIG. 7 shows a sequence diagram illustrating operation according to a third embodiment of the present disclosure.

FIG. 8 shows a sequence diagram illustrating operation according to a fourth embodiment of the present disclosure.

FIG. 9 shows a sequence diagram illustrating operation according to a sixth embodiment of the present disclosure.

### DETAILED DESCRIPTION OF EMBODIMENTS

Hereinafter, the following description for carrying out the present disclosure is accomplished. The description is done in the following order.

1. Configuration of service providing system

2. First embodiment (online check method)

3. Second embodiment (another online check method)

4. Third embodiment (online simple check method)

5. Fourth embodiment (offline check method)

6. Fifth embodiment (another check method)

7. Sixth Embodiment (if another service providing apparatus)

### 1. Configuration of Service Providing System

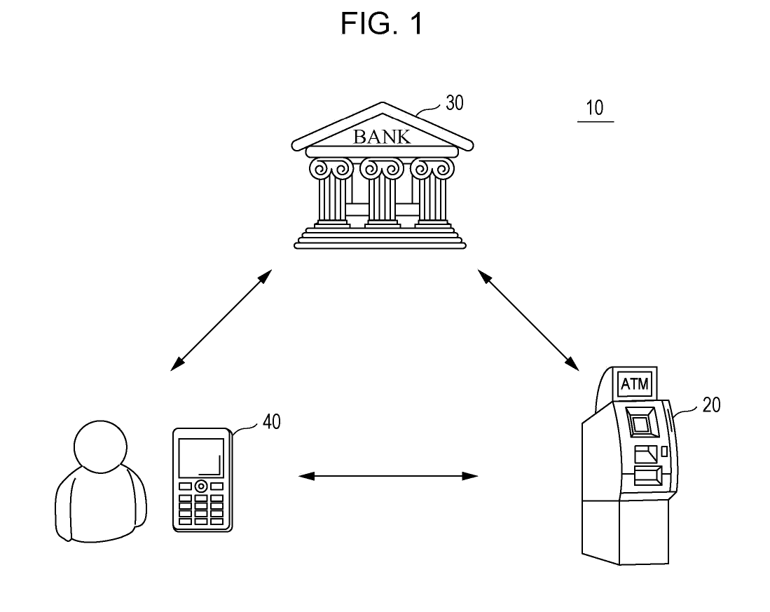

FIG. 1 shows a configuration of a service providing system. The service providing system 10 includes a service providing apparatus 20 providing a service to a user, a server managing the service providing apparatus and a portable communication terminal 40 operated by a service user. The service providing apparatus 20 provides the service in response to the request of a service user under the management of the server 30. The server 30 communicates with the portable communication terminal 40 of the service user so that the service user can determine the legitimacy of the service providing apparatus 20 by the portable communication terminal 40. Further, a legitimacy check of the service providing apparatus 20 is performed using a challenge and a response.

Next, the configuration for each apparatus of the service providing system will be described. Further, hereinafter, a case is illustrated where the service providing device 20 is an ATM (Automated teller machine) and the portable communication terminal 40 is a portable telephone.

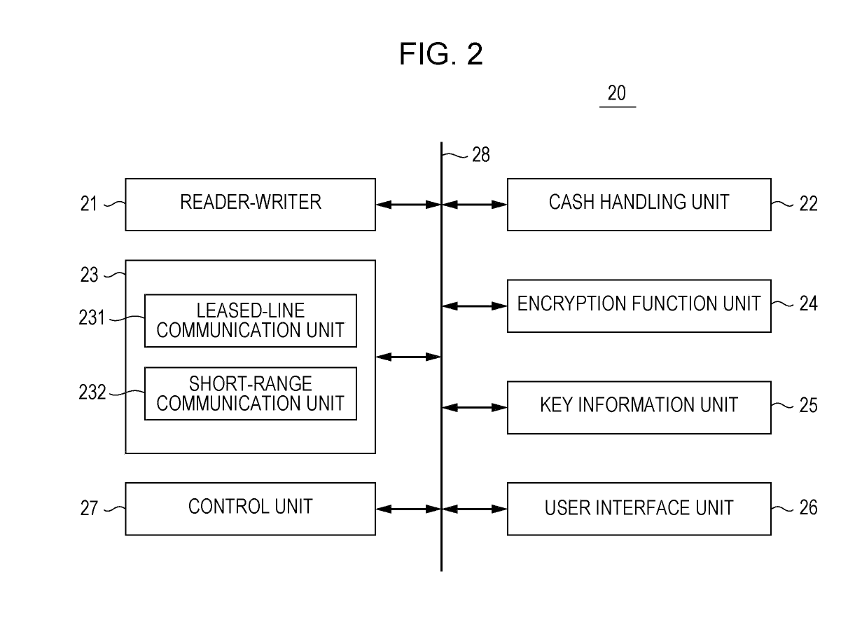

FIG. 2 shows a configuration of the service providing apparatus. The service providing apparatus 20 includes a reader-writer unit 21, a cash handling unit 22, a communication unit 23, an encryption function unit 24, a key information storage unit 25, a user interface unit 26 and a control unit 27.

The reader-writer unit 21 reads information recorded on a cash card or in a bankbook and the like inserted therein and updates recorded information. In addition, the reader-writer unit 21 has a function for printing and outputting details. The cash handling unit 22 performs deposits and withdrawals of coins and bills.

The communication unit 23 includes a dedicated line communication unit 231 and a short-range communication unit 232. The dedicated line communication unit 231 communicates with the server 30 via a dedicated line. The short-range communication unit 232 communicates with the portable communication terminal 40 using short-range wireless communication. The short-range communication unit 232 performs short-range wireless communication via a wireless communication channel using an a Bluetooth (trademark) or USB interface or the like, or NFC (Near Field Communication) using a built-in IC chip and the like.

The encryption function unit 24 performs encryption of information to be transmitted or decryption of the information received, when communicating via the communication unit 23. In addition, the encryption function unit 24 performs encryption of information to be recorded or decryption of the recorded information, when performing encryption of information to be recorded on the cash card and like.

The key information storage unit 25 stores the key information used when encrypting and decrypting by the encryption function unit 24 and calculating a response with a challenge-response scheme.

The user interface unit 26 is configured, for example, using a display unit with a touch panel and a voice output unit. The touch panel display unit is a display with input function and displays an operation screen on the screen of the display. In addition, the operation signals corresponding to operation of the touch panel are generated. The voice output unit outputs a voice, such as various types of guidance for the service user.

The control unit 27 controls each parts of the ATM to perform actions according to the operation by the service user. For example, the cash handling unit 22 performs a deposit process and a withdrawal process. In addition, the control unit 27 communicates with the server 30 and the portable communication terminal 40 so that the service user can determine the legitimacy of the ATM.

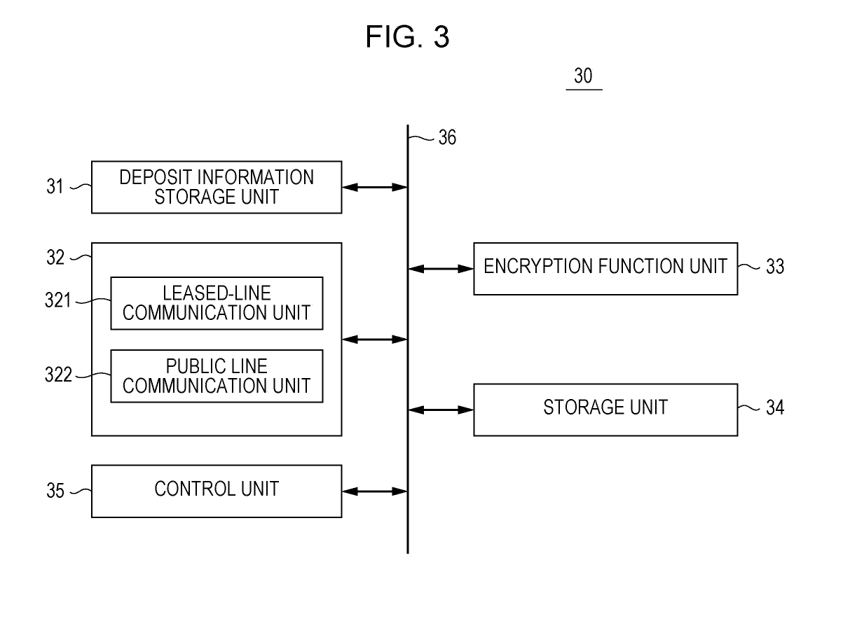

FIG. 3 shows the configuration of the server. The server 30 includes a deposit information storage unit 31, a communication unit 32, an encryption function unit 33, a storage unit 34 and a control unit 35.

The deposit information storage unit 31 stores the information such as each account balance and transaction history.

A communication unit 32 includes a dedicated line communication unit 321 and a public line communication unit 322. The leased line communication unit communicates with the service providing apparatus 20 via a leased line. The public line communication unit 322 communicates with the portable communication terminal 40 via the public communication network.

The encryption function unit 33 performs encryption of information to be transmitted or decryption of the received information, when communicating via the communication unit 32.

The storage unit 34 stores key information used when encrypting and decrypting in the encryption function unit 33 or the key information of each service providing apparatus 20.

The control unit 35 controls each part of the server to update the information such as each deposit balance and transaction history based on the result communicating with the service providing apparatus 20. In addition, the control unit communicates with the service providing apparatus 20 and the portable communication terminal 40 and performs a processing to determine the legitimacy of the ATM service users.

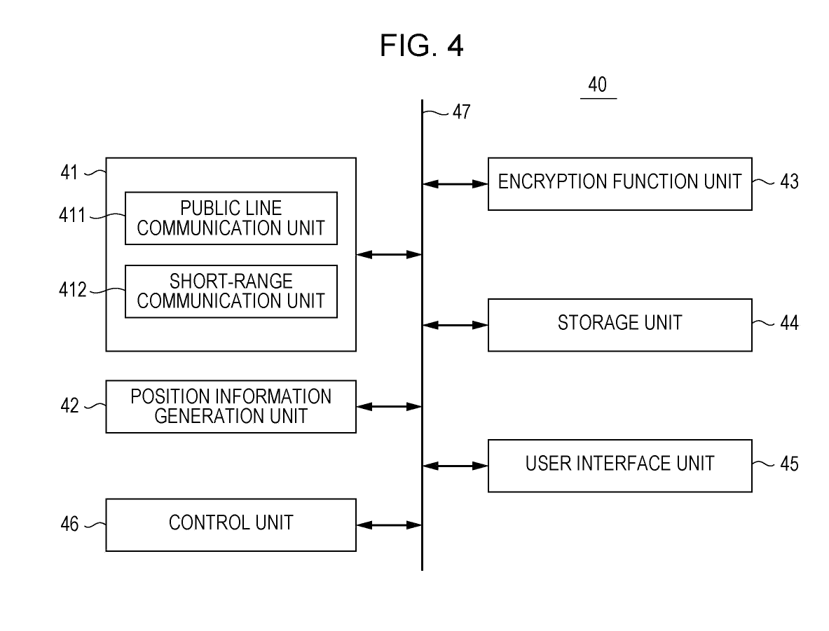

FIG. 4 shows a configuration of a portable communication terminal. The portable communication terminal includes a communication unit 41, a position information generation unit 42, an encryption function unit 43, a storage unit 44, a user interface unit 45 and a control unit 46.

The communication unit 41 includes a public line communication unit 411 and a short-range communication unit 412. The public line communication unit 411 communicates with server 30 via a public communication network. The short-range communication unit 412 communicates with the service providing apparatus 20 through the short-range wireless communication. The short-range communication unit 412 is configured similar to the short-range communication unit 232 of the service providing apparatus 20 and performs the short-range wireless communication via a wireless communication channel.

The position information generation unit 42 receives signals from for example, positioning satellites, etc. to generate position information indicating positions of a current portable communication terminal.

The encryption function unit 43 performs encryption of information to be transmitted and decryption of the received information, when communicating via the communication unit 41.

The storage unit 44 stores the key information used when encrypting and decrypting by the encryption function unit 43, or a program etc, supplied from the server 30 so as to determine the legitimacy of the service providing device 20.

The user interface unit 45 includes an operation unit, a speaker and a microphone. The operation unit generates an operation signal according to the operation of the service user to supply it to the control unit 46. A speaker outputs the voice of the other party. A microphone converts the voice of service user into the voice signals, such that the voice signals can be transmitted from the communication unit 41.

The control unit 46 controls each part of the portable communication terminal 40 to perform the action according to the operation of the service user. For example, the control unit 46 controls each parts so that it is possible to call with a desired opposite party, when performing call operation with the desired opposite party in the user interface unit 45. In addition, the control unit 46 communicates with the service providing apparatus 20 or the server 30 and performs a processing to determine the legitimacy of the ATM service user.

### 2. First Embodiment (Online Check Method)

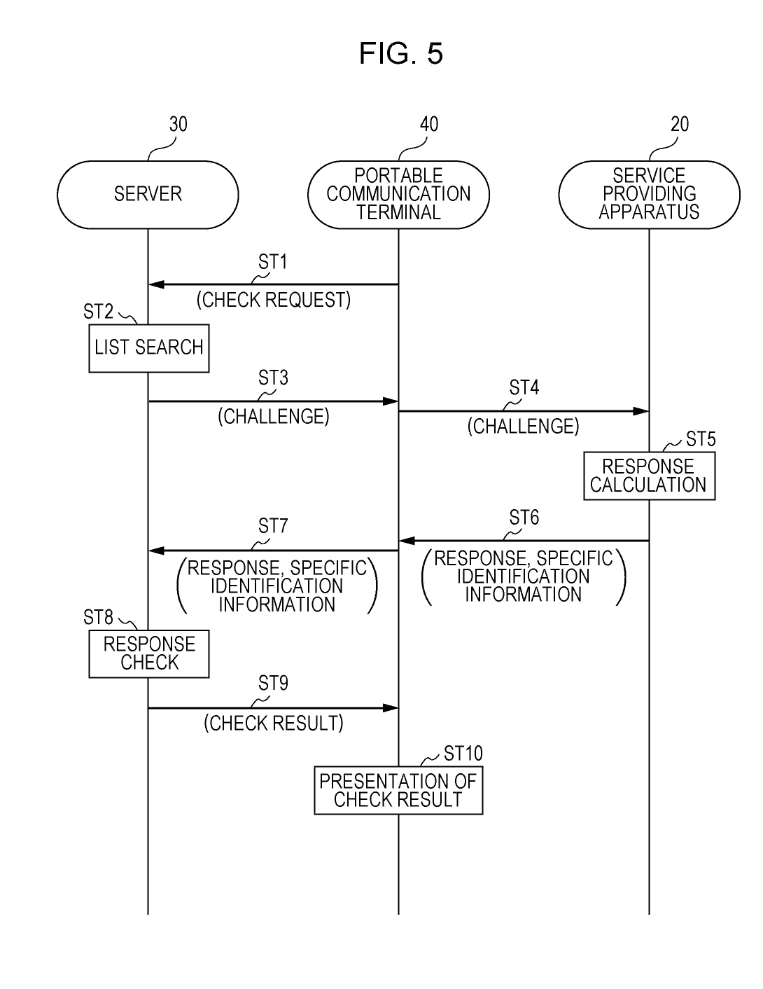

Then, FIG. 5 shows a case in which the legitimacy of the service providing apparatus 20 subjected to a legitimacy check can be detected online by the server 30. For example, FIG. 5 shows the case that the legitimacy of ATM is checked online before using ATM by service user.

The portable communication terminal 40 performs a request for the legitimacy check for the server 30 in step ST1. The control unit 46 of the portable communication terminal 40 communicates with the server 30 via the public line communication unit 411 according to the check request operation when performing the request operation of the legitimacy check for the user interface unit 45 and performs the request for the legitimacy check for the server 30. In addition, the control unit 46 performs the check request while including the information indicating the current position of the portable communication terminal, that is, the position information generated by the position information generating unit 42.

The server 30 performs a list search in step ST2. The control unit 35 of the server 30 detects a service providing apparatus disposed at the position indicated by the position information included in the check request, from a list of the service providing apparatuses stored in a storage unit 34 when the request for the legitimacy check is performed from the portable communication terminal 40.

The server 30 generates a challenge to transmit to the portable communication terminal 40 in step ST3. The control unit 35 of the server 30 generates a challenge and transmits from the public line communication unit 322 to the portable communication terminal 40 when detecting the service providing apparatus 20 in step ST2. In addition, the control unit 35 transmits the check result which indicates the service providing apparatus to be illegitimate to the portable communication terminal 40, when not detecting a service providing apparatus disposed at the position indicated by the position information included in the check request, at the list search in step ST2.

The portable communication terminal 40 transfers the challenge in step ST4. The control unit 46 of the portable communication terminal 40 transfers the challenge supplied from the sever 30 via the public line communication unit 411 for the request for the legitimacy check, from the short-range communication unit 412 to the service providing apparatus 20.

The service providing apparatus 20 performs a response calculation in step ST5. The control unit 27 of the service providing apparatus 20 calculates the response using the challenge received and key information stored in a key information storage unit 25 by the encryption function unit 24 when receiving the challenge via the short-range communication unit 232.

The service providing apparatus 20 transmits the calculated response to the portable communication terminal 40 in step ST6. The control unit 27 of the service providing apparatus 20 transmits the response calculated by the encryption function unit 24 from the short-range communication unit 232 to the portable communication terminal 40. Further, the control unit 27 transmits unique identification information of the service providing apparatus together with the response in order to identify the service providing apparatus calculating the response.

The portable communication terminal 40 transfers the response in step ST7. The control unit 46 of the portable communication terminal 40 transfers the response supplied via the short-range communication unit 412 from the service providing apparatus 20 and the unique identification information after the transfer of challenge, from the public line communication unit 411 to the server 30. Further, the control unit 46 transfers the unique identification information together with the response.

The server 30 performs the response check in step ST8. The control unit 35 of the server 30 determines the service providing apparatus 20 calculating the response based on the unique identification information supplied together with the response, when supplying the response from the portable communication terminal 40. The control unit 35 reads the key information corresponding to the determined service providing apparatus from the storage unit 34 to supply to the encryption function unit 33. Therefore, the response is calculated using the key information and the challenge to be transmitted according to the request for the legitimacy check from the portable communication terminal 40. In addition, the control unit 35 compares the received response with the response calculated by the encryption function unit 33, such that when the responses match each other, the service providing apparatus is determined to be legitimate and when the responses do not match each other, the service providing apparatus is determined to be illegitimate.

The server 30 transmits the check result to the portable communication terminal 40 in step ST9. The control unit 35 of the server 30 transmits the check result acquired by the response check of step ST8 from the public line communication unit 322 to the portable communication terminal 40.

The portable communication terminal 40 presents the check result in step ST10. The control unit 46 of the portable communication terminal 40 displays the check result supplied from the server 30, for example, on the display screen of the user interface unit 45.

Thus, according to a first embodiment, it is possible to determine easily whether or not the service providing apparatus subjected to the legitimacy check is legitimate using the portable communication terminal. Further, since the legitimacy check based on the generation of a challenge or response calculated by the service providing apparatus is performed online by the server 30, a load of the portable communication terminal 40 can be reduced when checking the legitimacy of the service providing apparatus.

### 3. Second Embodiment (Another Online Check Method)

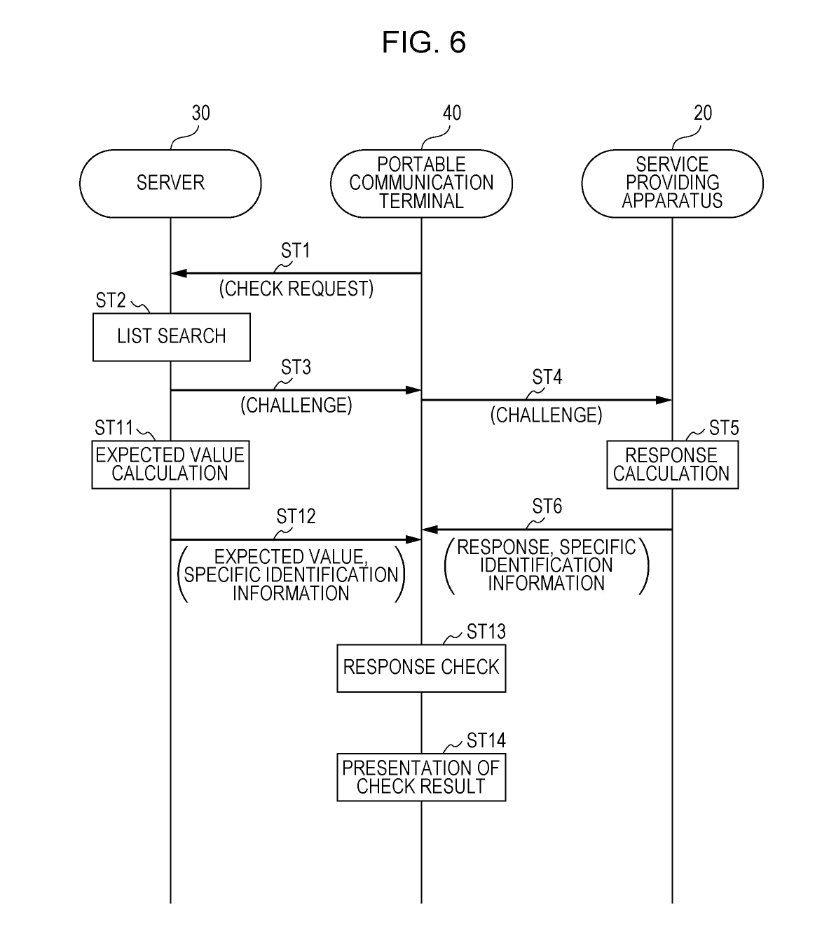

In the first embodiment above, although describing a case in which the legitimacy check of the service providing apparatus 20 subjected to the legitimacy check is performed by the server 30, it is also possible to perform the legitimacy check of the service providing apparatus 20 by the portable communication terminal 40. Then, in the second embodiment, FIG. 6 shows the case in which the legitimacy check of the service providing apparatus 20 is performed by the portable communication terminal 40. In addition, in FIG. 6, the same step numbers are applied to the corresponding processes of FIG. 5.

The portable communication terminal 40 performs the request for the legitimacy check for the server 30 in step ST1. The control unit 46 of the portable communication terminal 40 communicates with the server 30 via the public line communication unit 411 according to the check request operation when performing the request operation of the legitimacy check for the user interface unit 45 and performs the request for the legitimacy check for the server 30. In addition, the control unit 46 performs the check request while including the information indicating the current position of the portable communication terminal, that is, the position information generated by the position information generation unit 42.

The server 30 performs the list search in step ST2. The control unit 35 of the server 30 detects the service providing apparatus disposed at the position indicated by the position information included in the check request, from a list of the service providing apparatuses stored in a storage unit 34 when performing the request for the legitimacy check from the portable communication terminal 40.

The server 30 generates a challenge to transmit to the portable communication terminal 40 in step ST3. The control unit 35 of the server 30 generates a challenge and transmits from the public line communication unit 322 to the portable communication terminal 40 when detecting the service providing apparatus 20 in step ST2. In addition, the control unit 35 transmits the check result which indicates the service providing apparatus to be illegitimate to the portable communication terminal 40, when not detecting the service providing apparatus disposed at the position indicated by the position information included in the check request, at the list search in step ST2.

The portable communication terminal 40 transfers the challenge in step ST4. The control unit 46 of the portable communication terminal 40 transfers the challenge supplied from the sever 30 via the public line communication unit 411 for the request for the legitimacy check, from the short-range communication unit 412 to the service providing apparatus 20.

The service providing apparatus 20 performs a response calculation in step ST5. The control unit 27 of the service providing apparatus 20 calculates the response using the received challenge and key information stored in a key information storage unit 25 by the encryption function unit 24 when receiving the challenge via the short-range communication unit 232.

The service providing apparatus 20 transmits the calculated response to the portable communication terminal 40 in step ST6. The control unit 27 of the service providing apparatus 20 transmits the response calculated by the encryption function unit 24 from the short-range communication unit 232 to the portable communication terminal 40. Further, the control unit 27 transmits unique identification information of the service providing apparatus together with the response in order to identify the service providing apparatus calculating the response.

The server 30 is performed to calculate the expected value in step ST11. The control unit 35 of the server 30 calculates the response generated by the service providing apparatus as the expected value when transmitting the challenge to the service providing apparatus disposed at the position indicated by the position information included in the check request.

The server 30 transmits the expected value to the mobile communication terminal 40 in step ST12. The control unit 35 of the server 30 transmits the expected value calculated in step ST11 from the public line communication unit 322 to the portable communication terminal 40. In addition, the control unit 35 preferably transmits the unique identification number of the service providing apparatus disposed at the position indicated by the position information included in the check request together with the expected value in order to identify whether or not the expected value corresponds to any of the service providing apparatus.

The portable communication terminal 40 performs the response check in step ST13. The control unit 46 of the portable communication terminal 40 compares the response supplied via the short-range communication unit 412 from the service providing apparatus 20 with the expected value supplied via the public line communication unit 411 from the server 30. If the service providing apparatus 20 subjected to the legitimacy check is the service providing apparatus disposed at the position indicated by the position information in the service providing apparatus managing the server 30, the expected value calculated by the server 30 and the response calculated by the service providing apparatus 20 match each other. Further, if the service providing apparatus 20 is illegitimate, the response matching with the expected value is not calculated in the service providing apparatus 20. Thus, the control unit 46 determines the service providing apparatus to be legitimate when the response and the expected value match each other, and determines the service providing apparatus to be illegitimate when the response and the expected value do not match each other. Since the control unit 46 compares the response with the expected value when the unique identification information supplied together with the expected value and the unique identification information supplied together with the response match each other, the legitimacy check can be performed more reliably.

The portable communication terminal 40 presents the check result in step ST14. The control unit 46 of the portable communication terminal 40 displays the result of the legitimacy check acquired in step ST13, for example, on the display screen of the user interface unit 45.

Thus, according to a second embodiment, it is possible to determine easily and reliably whether or not the service providing apparatus subjected to the legitimacy check is legitimate using the portable communication terminal.

### 4. Third Embodiment (Simple Check Online)

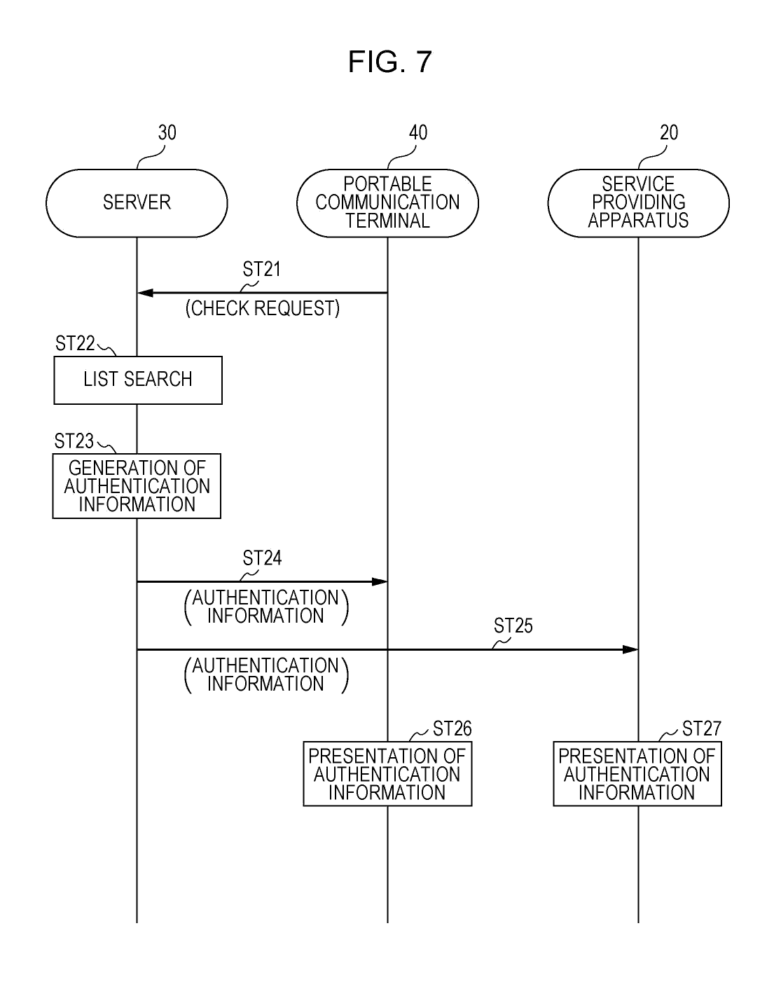

In the first embodiment and the second embodiment, the short-range communication is performed between the service providing apparatus 20 subjected to the legitimacy check and the portable communication terminal 40, and the communication of the challenge and the response are performed. However, there is also a case in which the short-range communication unit is not disposed in the service providing apparatus 20 or the portable communication terminal 40. Thus, in the third embodiment, FIG. 7 shows the case that the legitimacy of the service providing apparatus can be detected online without using the short-range communication unit.

The portable communication terminal 40 performs check request for the legitimacy for the server 30 in step ST21. The control unit 46 of the portable communication terminal 40 communicates with the server 30 via the public line communication unit 411 according to the check request operation when performing the request operation of the legitimacy check for the user interface unit 45 and performs request for the legitimacy check for the server 30. In addition, the control unit 46 performs the check request while including the information indicating the position of the current portable communication terminal, that is, the position information generated by the position information generation unit 42.

The server 30 performs the list search in step ST22. The control unit 35 of the server 30 detects the service providing apparatus disposed at the position indicated by the position information included in the check request, from a list of the service providing apparatuses stored in a storage unit 34 when performing the check request for the legitimacy from the portable communication terminal 40. In addition, the control unit 35 generates the check result which indicates the service providing apparatus to be illegitimate, when not detecting the service providing apparatus disposed at the position indicated by the position information included in the check request, at the list search.

The server 30 generates authentication information in step ST23. The control unit 35 of the server 30 does not perform a transmission of the challenge or a reception of the response via the portable communication terminal 40, when the communication between service providing apparatus 20 and the portable communication terminal 40 is not performed. Therefore, the control unit 35 of the server 30 generates the authentication information to enable user to determine the legitimacy of the service providing apparatus, when the portable communication terminal 40 does not display that the portable communication terminal 40 communicates with the service providing apparatus. As described below, the authentication information is information, for example, character information or numerical information, to easily determine whether or not the information match each other, when the service providing apparatus 20 and the portable communication terminal 40 present the authentication information. In addition, it is preferable that the authentication information uses an image and the like.

The server 30 generates the authentication information to transmit to the portable communication terminal in step ST24. The control unit 35 of the server 30 transmits the authentication information generated in step ST23 from the public line communication unit 322 to the portable communication terminal 40. In addition, when generating the check result which indicates the service providing apparatus to be illegitimate in step ST23, the control unit 35 transmits the check result from the public line communication unit 322 to the portable communication terminal 40.

The server 30 transmits the authentication information to the service providing apparatus 20 in step ST25. The control unit 35 of the server 30 transmits the authentication information generated in step ST23 from the dedicated line communication unit 321 to the service providing apparatus 20 detected in step ST22.

The portable communication terminal 40 presents the authentication information in step ST26. The control unit 46 of the portable communication terminal 40 displays the authentication information supplied from the server 30, for example, on the display screen of the user interface unit 45. Further, the control unit 46 displays the check result, for example, on the display screen of the user interface unit 45 when supplying the check result which indicates the service providing apparatus to be illegitimate from the server 30.

The service providing apparatus 20 presents the authentication information in step ST27. The control unit 46 of the portable communication terminal 40 displays the authentication information supplied from the server 30, for example, on the display screen of the user interface unit 45.

Thus, according to a third embodiment, when the legitimacy of the service providing apparatus 20 is verified, the same authentication information is presented by the service providing apparatus 20 and the portable communication terminal 40. Therefore, since the service user verifies whether or not the authentication information presented by the service providing apparatus 20 and the portable communication terminal 40 match each other, it is possible to easily determine that the service providing apparatus is legitimate.

In addition, in a third embodiment, even if the short-range communications unit is not provided to the service providing apparatus 20 and the portable communication terminal 40, the legitimacy of the service providing apparatus 20 can be verified. Therefore, the system can be constructed using already installed the service providing apparatus and a variety of the portable communication terminal.

### 5. Fourth Embodiment (Offline Check Method)

Then, an offline check will be described as the fourth embodiment. In the offline check, a program to check the legitimacy of the service providing apparatus 20 subjected to the legitimacy check is in advance provided to the portable communication terminal 40 from the server 30. The portable communication terminal 40 transmits the first program provided in advance to calculate the response and the challenge to the service providing apparatus 20 when checking the legitimacy of the service providing apparatus 20. In addition, since the second program provided in advance is performed, the legitimacy check is performed based on the response calculated by the service providing apparatus. Thus, the program provided in advance by the server 30 is performed by the portable communication terminal 40 and the check is performed without communication with the server 30 during the legitimacy check.

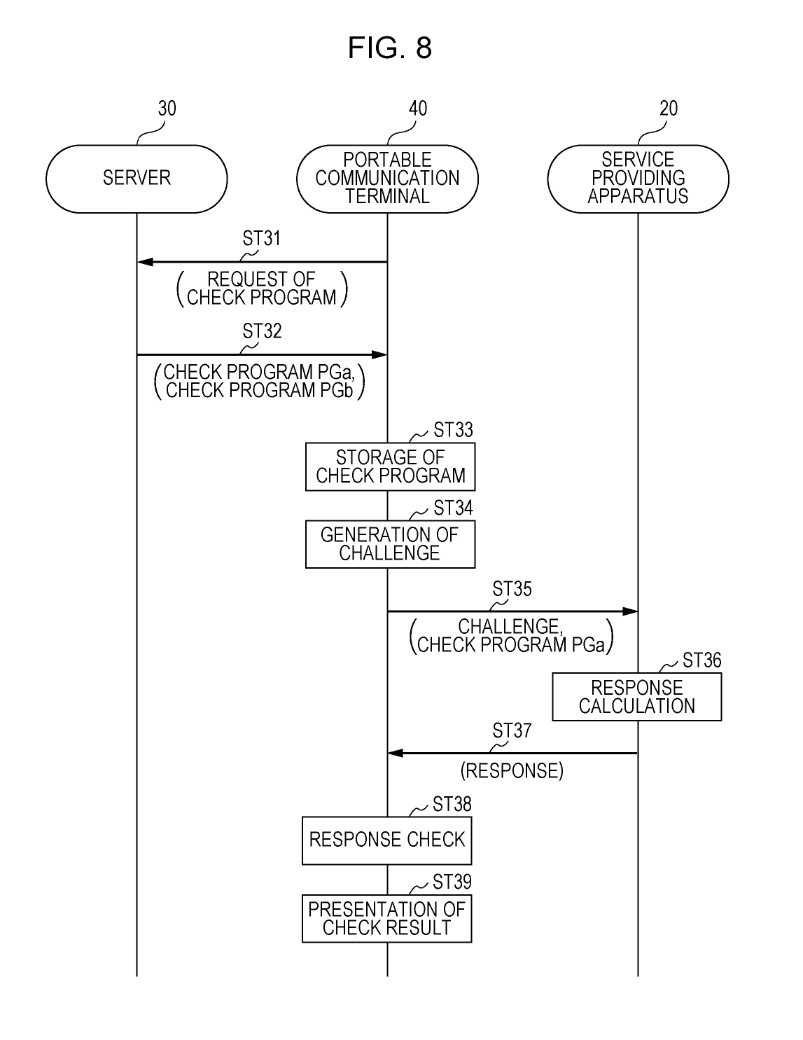

FIG. 8 is a sequence diagram showing the operation of the fourth embodiment. The portable communication terminal 40 requests a check program for performing offline check for server 30 in step ST31. The control unit 46 of the portable communication terminal 40 requests a check program to the server 30 via the public line communication unit 411 when performing the request operation of the check program by the user interface unit 45.

The server 30 provides the check program Pga, PGb in step ST32. The control unit 35 of the server 30 provides a check program PGa, PGb stored in advance in a storage unit 34 via the public line communication unit 322 for the portable communication terminal 40 requesting the check program. The check program PGa is the program that the portable communication terminal 40 provides to the service providing apparatus 20. The check program PGa calculates the response using the challenge supplied from the portable communication terminal 40. The check program PGb is the program checking the legitimacy of the service providing apparatus 20 using the response causing the first program to execute and calculate by the service providing apparatus 20 and is executed by the portable communication terminal 40. The legitimate service providing apparatus uses the transmitted challenge to calculate the response, at the check program PGb. When comparing the calculated response with the response supplied from the service providing apparatus 20, the legitimacy of the service providing apparatus 20 is checked, at the check program PGb.

The portable communication terminal 40 stores the check program in step ST33. The control unit 46 of the portable communication terminal 40 stores the check program PGa, PGb provided from the sever 30 in the storage unit 44.

The sever 30 and the portable communication terminal 40 performs such a process before the legitimacy check of the service providing apparatus 20 and in advance stores the check program PGa, PGb in the storage unit 44 of the portable communication terminal 40. Then, when the start operation of the legitimacy check is performed by the user interface unit 45, the portable communication terminal 40 performs the process of the step ST34.

The portable communication terminal 40 generates the challenge in step ST34. The control unit 46 of the portable communication terminal 40 executes the check program PGb to generate the challenge.

The portable communication terminal 40 transmits the challenge and the check program Pga to the service providing apparatus 20 performing the legitimacy check in step ST35. The control unit 46 of the portable communication terminal 40 transmits the check program PGa stored in the generated challenge and the storage unit 44 to the service providing apparatus 20 via the short-range communication unit 412.

The service providing apparatus 20 calculates the response in step ST36. The control unit 27 of the service providing apparatus 20 calculates the response by the encryption function unit 24 using the key information stored in the received challenge and the key information storage unit 25, when receiving the challenge via the short-range communication unit 232.

The service providing apparatus 20 transmits the calculated response to the portable communication terminal 40 in step ST37. The control unit 27 of the service providing apparatus 20 transmits the response calculated by the encryption function unit 24 from the short-range communication unit 232 to the portable communication terminal 40.

The portable communication terminal 40 performs a response check in step ST38. The control unit 46 of the portable communication terminal 40 calculates the response using the challenge generated in step ST34. In addition, when comparing the calculated response and the response supplied via the short-range communication unit 412 from the service providing apparatus 20, the control unit 46 determines the service providing apparatus to be legitimate in a case where both of responses match each other and determines the service providing apparatus to be illegitimate in a case where both of responses do not match each other.

The portable communication terminal 40 presents the check result in step ST39. The control unit 46 of the portable communication terminal 40 displays the check result acquired in step ST38, for example, on the display screen of the user interface unit 45.

Thus, according to a fourth embodiment, the check program is in advance stored in the portable communication terminal 40. Accordingly, although the service providing apparatus is disposed in a place where the server 30 does not communicate with the portable communication terminal 40, it is possible to easily check using the portable communication terminal whether or not the service providing apparatus is legitimate.

Further, according to the fourth embodiment, the server 30 adds a digital signature of the server 30 to the check program PGa, and the service providing apparatus 20 executes the check program PGa after verifying whether or not the digital signature is correct. In so doing, although the service providing apparatus 20 executes an illegitimate program, there is little risk of infection from a virus or the like.

In addition, it is preferable that the server 30 provides a list indicating a position to dispose the service providing apparatus together with the check program. In this case, the portable communication terminal 40 performs the process after step ST34, based on position information generated by the position information generation unit 42, when the service providing apparatus performing the legitimacy check is included in the list. In addition, when the service providing apparatus performing the legitimacy check is not included in the list, it is determined that the service providing apparatus is illegitimate, and when presenting the check result, it is possible to quickly detect the illegitimate service providing apparatus.

In addition, the fourth embodiment is performed in preference to the operation of the first or second embodiment. Further, it is preferable to perform when a communication between the server 30 and the portable communication terminal 40 is not performed.

### 6. Fifth Embodiment (The Other Check Method)

Meanwhile, a general ATM is interoperable between banks. For example, a user with an account at a bank A can withdraw money using an ATM of a bank B. However, it is assumed that the legitimacy for the ATM of bank B is not determined by the check program of the bank A.

In such cases, the check method may be used as follows. For example, the URL (Uniform Resource Locator) of the server of the bank itself (the server of the bank B, in the case of an ATM of the bank B) is posted on the ATM using a two-dimensional code or the like and the check is performed online as the first to third embodiment. As another method, when the portals for the server of each bank are unified, the URLs become the same, no matter which bank's ATM is checked. When accessing such a portal, a connection destination is automatically changed to the server of the bank managing the ATM based on the unique identification information of the ATM and therefore the check is performed online as in the first to third embodiments.

In addition, a check program capable of checking the ATMs of a plurality of banks or a check program of ATMs from other banks is provided and received, and the check program of ATMs from other banks may be provided together with the check program of the bank itself. In addition, the check program corresponding to the ATM can be used by selecting the check program when using the unique identification information of the ATM.

### 7. Sixth Embodiment (If Other Service Providing Apparatus)

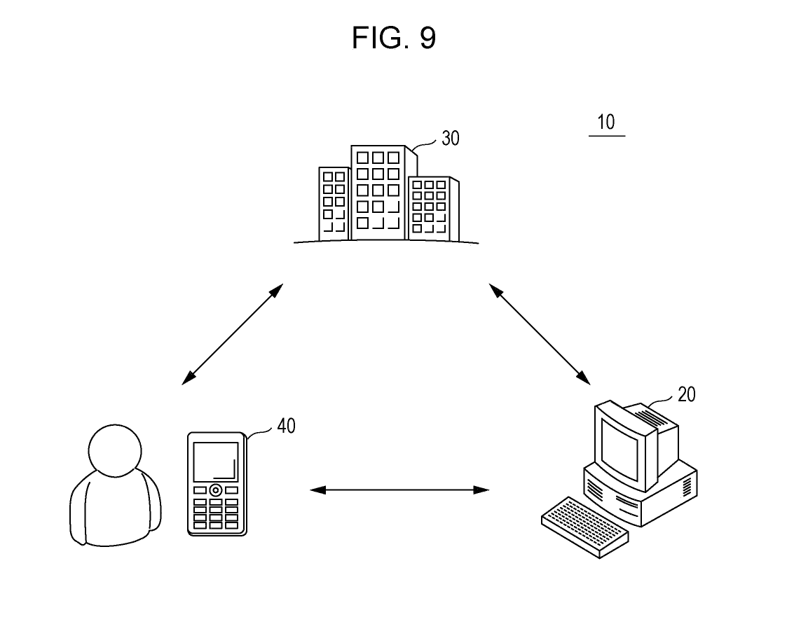

In addition, in the above-described embodiment, although describing a case that the service providing apparatus 20 includes the ATM, the service providing apparatus may include other electronic equipment such as personal computers. FIG. 9 shows an example of checking whether or not the personal computers include a key logger device or software when using the personal computers provided at an Internet cafe, or the like.

In the FIG. 9, the service providing apparatus 20 includes the personal computers equipped with Internet cafe, etc. The server 30 is the server of a PC manufacturer or a company, or the like, that provides a virus check program. The server 30 provides the check program which checks whether or not key logger software or device is attached to the service providing apparatus 20. Such a check program is created using a virus check program and the like.

The service providing apparatus 20 (personal computers) and the portable communication terminal 40 establishes a communication channel via Bluetooth(TM) or USB. In addition, communication channels such as NFC may be established.

Thus, although the service providing apparatus includes personal computers and the like, it is possible to easily determine using the portable communication terminal 40 whether or not the service providing apparatus is legitimate.

The present disclosure is not to be limited and construed to the embodiment thereof described above. For example, if performing a combination of the above-described embodiments, it is possible to perform the legitimacy check of the service providing apparatus depending on whether or not the communication between the portable communication terminal and the server or the communication between the portable communication terminal and the service providing apparatus is performed. In addition, this embodiment describes the disclosure as one example and it is obvious that it may be implemented without substitution or modification of the embodiments by those skilled in the art within a range not departing from the scope of the disclosure. In other words, the claims are to be taken into consideration when determining the gist of the disclosure.

The present disclosure contains subject matter related to that disclosed in Japanese Priority Patent Application JP 2010-244057 filed in the Japan Patent Office on Oct. 29, 2010, the entire contents of which are hereby incorporated by reference.

What is claimed is:

1. A service providing system, comprising:
a portable communication terminal operated by a user;
a service providing apparatus providing a service to the user, and
a server managing the service providing apparatus,
wherein the service providing apparatus calculates a response using a challenge, and
the portable communication terminal transmits a challenge generated by the server to the service providing apparatus subjected to a legitimacy check of the service providing apparatus and presents a result of the legitimacy check based on a response calculated by the service providing apparatus subjected to the legitimacy check using the transmitted challenge.

2. The service providing system according to claim 1,
wherein the portable communication terminal transmits the challenge supplied from the server to the service providing apparatus subjected to the legitimacy check in response to the transmission of position information displaying a current position to the server, transmits the response supplied from the service providing apparatus subjected to the legitimacy check to the server in response to the transmission of the challenge, and presents the result of the legitimacy check supplied from the server in response to the response transmission, and
the server transmits the challenge corresponding to the service providing apparatus at a position indicated by the position information to the portable communication terminal, checks the legitimacy of the service providing apparatus subjected to the legitimacy check based on the response supplied from the portable communication terminal and transmits the result of the legitimacy check to the portable communication terminal.

3. The service providing system according to claim 2,
wherein the service providing apparatus subjected to the legitimacy check calculates the response using the key information and the challenge, and transmits the calculated response together with the unique identification information of the service providing apparatus subjected to the legitimacy check, and
the server determines the key information from the unique identification information, compares the response calculated using the determined key information and the transmitted challenge with the response calculated by the service providing apparatus subjected to the legitimacy check, and checks the legitimacy of the service providing apparatus subjected to the legitimacy check.

4. The service providing system according to claim 1,
wherein the server transmits the challenge corresponding to the service providing apparatus at a position indicated by the position information, and an expected value displaying the response calculated by the service providing apparatus at the position indicated by the position information using the challenge to the portable communication terminal, and
the portable communication terminal transmits the challenge supplied from the server to the service providing apparatus subjected to the legitimacy check in response to the transmission of position information displaying a current position to the server, checks the legitimacy of the service providing apparatus subjected to the legitimacy check to the server using the response supplied from the service providing apparatus subjected to the legitimacy check and the expected value supplied from the server in response to the transmission of the challenge to the service providing apparatus subjected to the legitimacy check, and presents the result of the legitimacy check,

5. The service providing system according to claim 1,
wherein the server transmits authentication information that enables the user to determine the legitimacy for the portable communication terminal and the service providing apparatus at the position indicated by the position information, when the portable communication terminal does not display that the portable communication terminal is able to communicate with the service providing apparatus subjected to the legitimacy check, and
the service providing apparatus subjected to the legitimacy check and the portable communication terminal present the authentication information.

6. A service providing method for a service providing system including a portable communication terminal operated by a user, a service providing apparatus providing a service to the user, and a server managing the service providing apparatus,
the service providing method, comprising:
calculating a response using a challenge in the service providing apparatus;
transmitting, by the portable communication terminal, a challenge generated by the server to the service providing apparatus subjected to a legitimacy check among the service providing apparatuses, and
presenting, by the portable communication terminal, a result of the legitimacy check based on the response calculated by the service providing apparatus subjected to the legitimacy check using the transmitted challenge.

7. A portable communication terminal, comprising
a position information generating unit generating a position information displaying a current position;
a communication unit communicating a service providing apparatus providing a service to a user with a server managing the service providing apparatus, and
a control unit transmitting a challenge generated by the server to the service providing apparatus subjected to the legitimacy check among the service providing apparatus and presenting the result of the legitimacy check based on a response calculated by the service providing apparatus subjected to the legitimacy check using the transmitted challenge.

8. A server, comprising:
a communication unit communicating a service providing apparatus providing a service to a user with a portable communication terminal operated by a user, and
a control unit transmitting a challenge to a portable communication terminal, checking legitimacythe legitimacy of a service providing apparatus disposed at a position displayed by a position information based on a response supplied from the portable communication terminal, and transmitting a result of legitimacythe legitimacy check to the portable communication terminal, when disposing the service providing apparatus at the position displayed by the position information supplied from the portable communication terminal.

9. The server according to claim 8,
wherein the control unit transmits authentication information to enable a user to determine the legitimacy for the service providing apparatus at the position displayed by the position information supplied from the portable communication terminal, and the portable communication terminal, when the portable communication terminal does not display that the portable communication terminal is able to communicate with the service providing apparatus subjected to the legitimacy check.

10. A service providing system, comprising:
a portable communication terminal operated by a user;
a service providing apparatus providing a service to the user, and
a server managing the service providing apparatus,
wherein the server transmits a first program calculating a response using a challenge and a second program checking the legitimacy for the service providing apparatus subjected to the legitimacy check using the response obtained by allowing the service providing apparatus subjected to the legitimacy check among the service providing apparatus to execute and calculate the first program to the portable communication terminal,
the portable communication terminal executes the second program, and checks the legitimacy of the service providing apparatus subjected to the legitimacy check using the response supplied from the service providing apparatus subjected to the legitimacy check in response to the transmission of the challenge and the first program to the service providing apparatus subjected to the legitimacy check and,
the service providing apparatus subjected to the legitimacy check executes the first program supplied from the portable communication terminal to calculate the response using the challenge and transmits the calculated response to the portable communication terminal.

11. The service providing system according to claim 10,
wherein the server transmits a list displaying a position of a legitimate service providing apparatus together with the first program and the second program to the portable communication terminal,
the portable communication terminal is determined to be an illegitimate service providing apparatus, when the service providing apparatus subjected to the legitimacy check corresponding to a current position is not included in the list.

12. A service providing method for a service providing system including a portable communication terminal operated by a user; a service providing apparatus providing a service to the user, and a server managing the service providing apparatus,
the service providing method, comprising:
transmitting, by the server, a first program calculating a response using a challenge and a second program checking legitimacy the legitimacy of the service providing apparatus subjected to the legitimacy check using the response obtained by allowing the service providing apparatus subjected to the legitimacy check among the service providing apparatus to execute and calculate the first program to the portable communication terminal,
executing, by the portable communication terminal, the second program, and checking the legitimacy of the service providing apparatus subjected to the legitimacy check using the response supplied from the service providing apparatus subjected to the legitimacy check in response to the transmission of the challenge and the first program to the service providing apparatus subjected to the legitimacy check, and
executing, by the service providing apparatus subjected to the legitimacy check, the first program supplied from the portable communication terminal to calculate the response using the challenge and transmitting the calculated response to the portable communication terminal.

13. A portable communication terminal, comprising
a communicating unit acquiring a first program calculating a response using a challenge when the service providing apparatus providing the service for the user is communicated with the server managing the service providing apparatus and a second program checking legitimacy the legitimacy of the service providing apparatus subjected to the legitimacy check using the response obtained by allowing the service providing apparatus subjected to the legitimacy check among the service providing apparatus to execute and calculate the first program, and
a control unit executing the second program, checking the legitimacy of the service providing apparatus subjected to the legitimacy check using the response supplied from the service providing apparatus subjected to the legitimacy check in response to the transmission of the challenge and the first program to the service providing apparatus subjected to the legitimacy check, and presenting a result of the legitimacy check.

14. A server managing a service providing apparatus providing a service to a user, comprising:
a communication unit communicating with a portable communication terminal operated by a user, and
a control unit providing a first program calculating a response using a challenge according to a request from the portable communication terminal and a second program checking legitimacy the legitimacy of the service providing apparatus subjected to the legitimacy check using the response obtained by allowing the service providing apparatus subjected to the legitimacy check among the service providing apparatus to execute and calculate the first program to the portable communication terminal.
